(19) United States
(12) Patent Application Publication
(10) Pub. No.: US 2013/0158802 A1
(43) Pub. Date: Jun. 20, 2013

(54) Steering System for Crawler Track Machine

(71) Applicants: Nathan Wayne Miller, Plymouth, MN (US); John Eron Jorgensen, Andover, MN (US); Daniel Harry Killion, Blaine, MN (US)

(72) Inventors: Nathan Wayne Miller, Plymouth, MN (US); John Eron Jorgensen, Andover, MN (US); Daniel Harry Killion, Blaine, MN (US)

(73) Assignee: CATERPILLAR PAVING PRODUCTS INC., Minneapolis, MN (US)

(21) Appl. No.: 13/328,652

(22) Filed: Dec. 16, 2011

(51) Int. Cl. B62D 6/00

(52) U.S. Cl. 701/41

(57) ABSTRACT

A crawler track machine such as a cold planar milling machine may incorporate a steering system having multiple steering modes including coordinated steering modes as well as an improved crab mode. Orientations of front and rear pairs of crawler tracks may be managed via a linear actuator control system adapted to dynamically adjust lengths of front and rear tie rods. In one disclosed embodiment, the machine may include at least a coordinated four-track steering mode, an independent front track steering mode, and a crab mode. The crab mode may involve use of automated linear actuators on the tie rods to assure that all tracks remain substantially parallel to one another, and may involve the use of lookup tables to coordinate actuator movements in response to individual parallel track angle demands as a function of steering inputs.

### TECHNICAL FIELD

This disclosure relates to steering systems for machines having continuous tracks, and more particularly to an improved steering system adapted to accommodate multiple steering modes.

### BACKGROUND

Continuous track machines, and particularly road milling machines variously called cold milling machines, are useful to scarify, remove, mix, or reclaim material from bituminous, concrete, or asphalt on roadway beds. To enhance maneuverability, such machines often utilize multiple steering modes, including, for example, a “crab” as well as the more typical so-called “coordinated” steering modes. In a crab mode all tracks of the machine are oriented parallel to one another, and thus aligned to collectively roll in a single direction.

More particularly, during the crab mode, the machine travels linearly in the direction of its parallel oriented tracks, albeit at an angle relative to a longitudinal centerline of the machine. In a coordinated steering mode, the machine will move in a circular turning direction about a single radial point, as dictated by orientation of the machine's front and rear tracks. A coordinated steering mode may occur, for example, when the front tracks are oriented in one direction and the rear tracks in an opposite direction.

Current milling machines have been limited to successful executions of “coordinated” steering modes only, as a fixed length tie rod is typically utilized between both front and rear sets of tracks. Although most machines have steering linkages designed and adapted to approximate perfectly coordinated so-called “Ackerman” turns during executions of their coordinated steering modes, their fixed length tie rods fail to accommodate satisfactory executions of crab steering, during which mode all tracks must be substantially parallel to avoid scuffing and/or skipping. Indeed, when not parallel during a crab, the tracks will often appear to be fighting one another.

To date, efforts to achieve satisfactory multiple steering modes have tended to involve significant complexity, for example as that disclosed in U.S. Pat. No. 7,942,604 B2, entitled “Propulsion and Steering System for a Road Milling Machine”. The present disclosure seeks to provide for successful application of multiple steering modes without levels of complexity that may have been formerly required.

### SUMMARY OF THE DISCLOSURE

In accordance with one aspect of the present disclosure, a four-track machine, such as a cold planar crawler track milling machine, has multiple steering modes, including at least one coordinated steering mode and a successfully executable crab mode.

In accordance with another aspect of the present disclosure, the machine includes at least three primary steering modes: a four-track coordinated steering mode, an independent front track steering mode, and a crab mode.

In accordance with yet another aspect of the present disclosure, the machine provides that each of the machine's front and rear pairs of crawler tracks employs a dynamically adjustable tie rod, and includes capability for operator selection between desired steering modes.

In accordance with yet another aspect of the present disclosure, the adjustable tie rod incorporates a linear actuator adapted to provide real-time adjustments to assure that all tracks remain substantially parallel to one another during the crab mode.

In accordance with yet another aspect of the present disclosure, the multiple steering modes are adapted for use in a cold milling machine, and involve an automated system for controlling a linear actuator on each tie rod, including use of lookup tables to match linear actuator movements with individual parallel track angle demands.

In accordance with yet another aspect of the present disclosure, the automated linear actuated control system may be adapted to selectively place or park the adjustable tie rods in a predetermined fixed position during a non-crab machine steering mode; i.e., during any Ackerman coordinated steering mode.

### BRIEF DESCRIPTION OF THE DRAWINGS

FIG. 1 is a perspective view of a machine that may embody elements of the present disclosure;

FIG. 2 is a plan view of front and rear pairs of tracks of the machine of FIG. 1, depicted in a configuration adapted to produce a coordinated turn.

FIG. 3 is a plan view of a front pair of tracks of the machine of FIG. 1 in a configuration adapted to produce a coordinated right turn.

FIG. 4 is a plan view of the front pair of tracks of FIG. 3 in a configuration adapted to produce a coordinated left turn.

FIG. 5 is a plan view of the front and rear pairs of tracks of FIG. 2, oriented in a configuration adapted to produce crab steering.

FIG. 6 is a schematic portrayal of a linear actuator control system, including an adjustable tie rod, several hydraulic components, and a cross-sectional view of a linear actuator that may embody elements of the present disclosure.

FIG. 7 is a block diagram depicting a method of operation of the linear actuator control system of the present disclosure.

### DETAILED DESCRIPTION

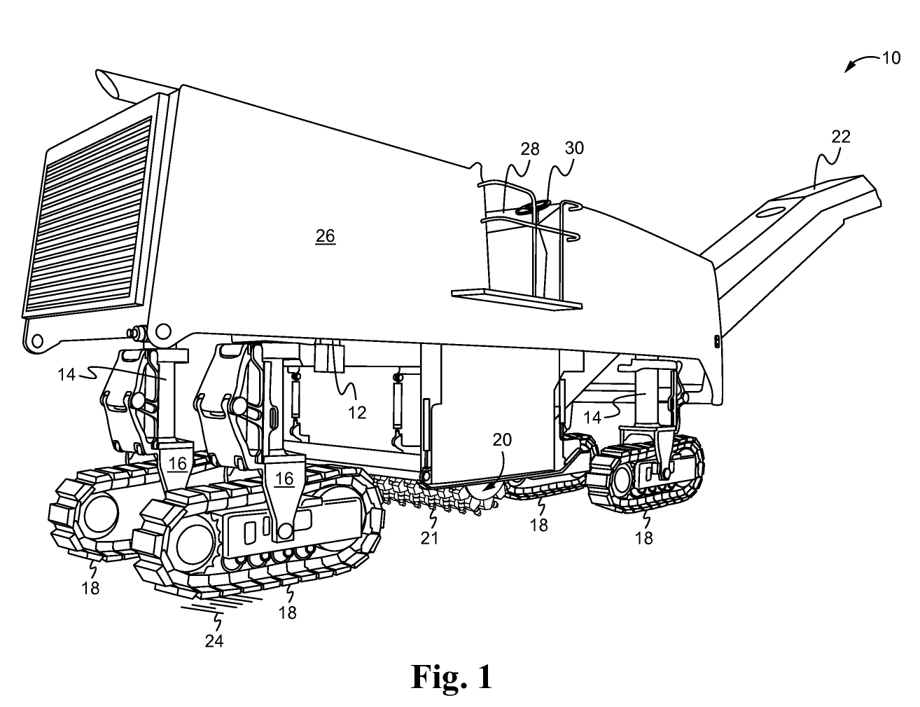

Referring initially to FIG. 1, a crawler track machine 10 may embody the disclosed steering system. The machine 10 may be supported by an undercarriage frame 12 from which may extend vertical support columns, also called legs, 14. Pairs of front and rear crawler tracks 18 may be attached to the columns 14, each track being rotatably coupled to one support column 14 by a yoke 16 which may serve as a steering pivot for each track 18.

The machine 10 may incorporate a centrally positioned asphalt removal drum 20, adapted to scarify and remove surface material from an old, worn, or existing roadbed in preparation for the installation of a new roadbed. The drum 20 may incorporate exterior teeth 21 adapted to remove asphalt or concrete, for example as discrete particles from the existing roadbed surface 24, and to convey those particles to an adjacent excavation or dump truck (not shown) through a conveyor apparatus 22. The machine may further incorporate a cab unit 26 that includes an operator station 28 having a steering control unit, for example the wheel 30, as shown.

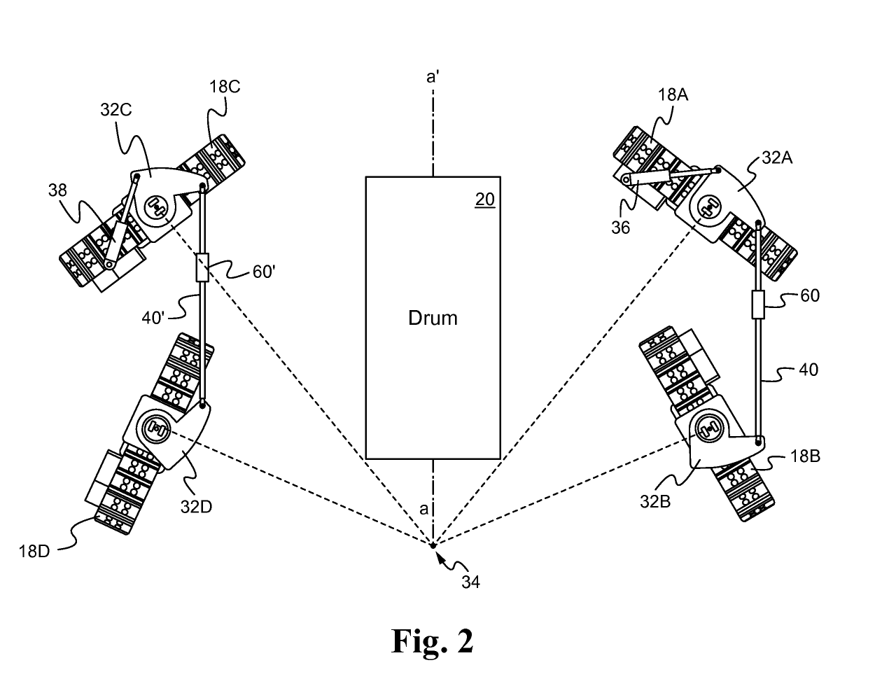

Referring now to FIG. 2, front and rear crawler tracks 18 may be utilized to propel the machine 10 (FIG. 1), and to maneuver the machine 10 over the roadbed surface 24. In FIG. 2, the tracks 18 are depicted in a so-called Ackerman “coordinated” right turn, during which each track 18A through 18D rotates about a single radial point 34 that lies on the centerline a-a′ of the removal drum 20. Such a coordinated turn requires that each individual track 18A through 18D turns about the same center of rotation; i.e., in this case, the point 34. Thus, neither the pair of front tracks, i.e. front left track 18A and front right track 18B, nor the pair of rear tracks, i.e. rear left track 18C and rear right track 18D, are ever parallel to one another during a coordinated turn, as each track must revolve in an arc on its own radius about a common center point of rotation. Those skilled in the art will appreciate that such a coordinated turn will avoid any inefficiency introduced by skidding or slipping of individual tracks 18 that might otherwise occur. During the turning of the machine 10, such coordinated turns may be achieved via design of a predetermined fixed steering linkage geometry; i.e., without any practical requirement for dynamic adjustment of tie rod length.

Although the term “Ackerman” is used throughout this disclosure to describe characteristics of coordinated turns carried out by the machine 10, those skilled in the art will appreciate that such turns may not always be precisely “Ackerman” coordinated, to the extent that an Ackerman turn generally represents an ideal rather than a consistently and perfectly executed reality.

A front steering actuator 36 and a rear steering actuator 38 are displayed in FIG. 2. The steering actuators 36, 38 may be controlled by the steering control unit 30 (FIG. 1) adapted to produce the coordinated turn displayed in FIG. 2 via the noted steering linkage. Those skilled in the art will also appreciate that the exemplary coordinated turn depicted is dynamic, and will thus occur in a variety of angular orientations, and not only the single angular orientation or arrangement displayed in FIG. 2.

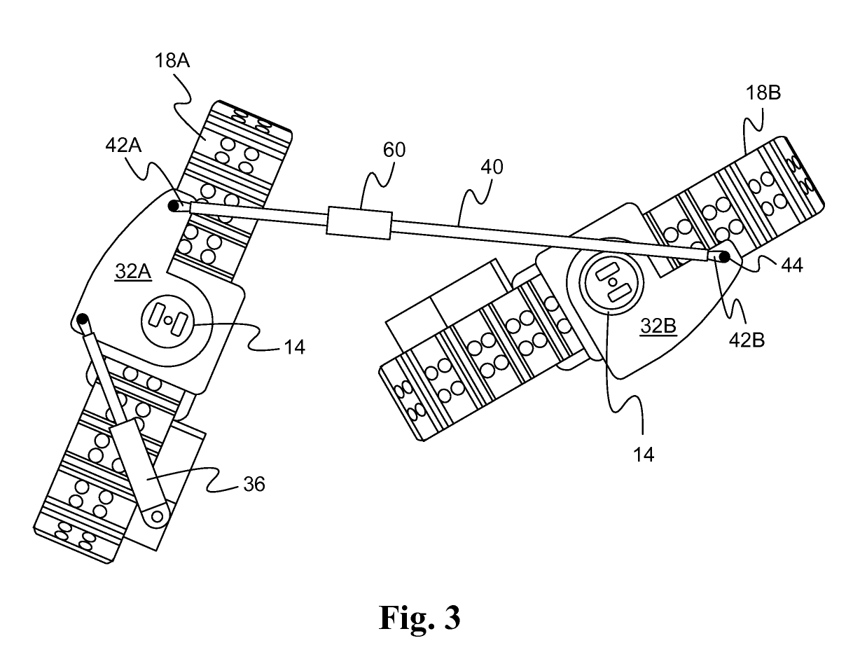

Referring now to FIG. 3, only the left and right front pair of tracks 18A and 18B are depicted in an Ackerman coordinated right turn. In order to assure coordinated turns, a front tie rod 40 includes tie rod ends 42A and 42B that couple the tracks 18A and 18B together. The actual coupling may be achieved through interconnection of respective left and right steering collar assemblies 32; thus each tie rod end 42A and 42B may be rotatably secured to steering collar assemblies 32A and 32B, respectively. The steering collar assemblies 32 may be fixedly secured to the earlier referenced vertical support columns 14, and may include steering collar coupling apertures 44 through which are pinned the tie rod ends 42A and 42B.

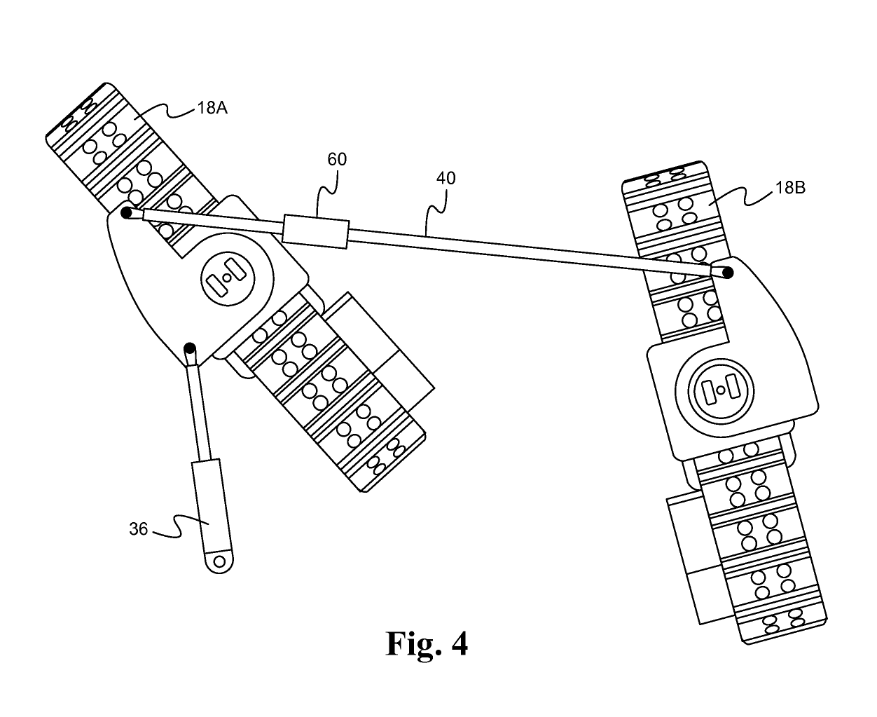

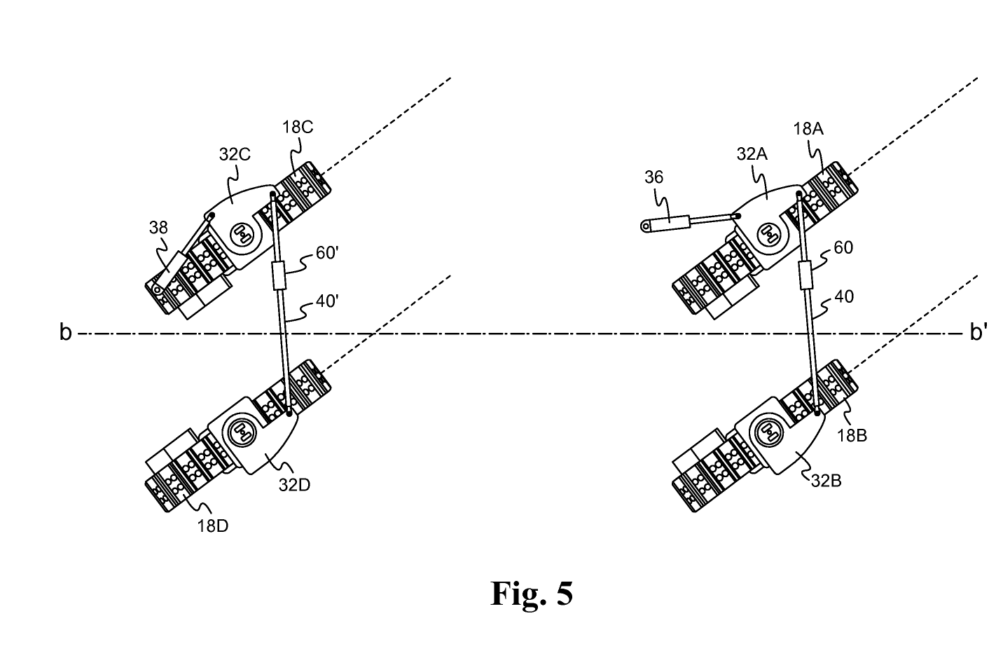

While FIG. 3 displays one orientation of the tracks 18A and 18B during a coordinated right turn, FIG. 4 depicts an orientation of the same tracks, 18A and 18B, during a coordinated left turn. For desired operability of the machine 10, a linear actuator 60 is normally adapted to provide an adjustable tie rod capability for the crab steering mode (described below in greater detail in reference to FIG. 5). The linear actuator 60 may be parked or fixed in a predetermined position in the machine 10 during any Ackerman coordinated left or right turn. In such case, and during any such non-crab or coordinated mode turn, the tie rod 40 may be provided to have a length equal to a predetermined steering linkage-fixed value (FIGS. 3 and 4).

The machine 10 of the present disclosure is contemplated to have at least two Ackerman steering modes. The first is the four-track (or all track) steering mode as described in reference to FIG. 2. The second is an independent front track steering mode in which only the front tracks are intentionally manipulated by an operator, and during which time the rear tracks may be normally biased to a zero turn angle. Thus, the respective displays of left and right turning front tracks 18A and 18B of FIGS. 3 and 4 may also represent an independent front steer Ackerman coordinated mode, as opposed to the four-track Ackerman coordinated turn previously described.

In addition to the described steering modes, a rear steer override feature may be used to “override” any of the aforedescribed active modes to provide an enhanced flexibility in maneuvering the machine 10.

As suggested above, during any of the Ackerman modes, it is contemplated that the actuator 60 will be parked or otherwise fixed in a predetermined position. Indeed, the built-in steering linkage will be sufficient to provide operable Ackerman turn capabilities without necessity of any real time tie rod adjustments.

For crab mode operations, however, the actuator 60 as disclosed and described herein may be adapted to actively expand or retract the tie rod ends 42 as required for maintaining the tracks 18A and 18B in perfectly parallel alignment with one another during any executable crab mode angle, as will now be further described.

Referring specifically now to FIG. 5, a left crab mode orientation of all four pairs of front and rear tracks 18A through 18D is displayed. Those skilled in the art will appreciate that the so-called “parallel track”, or crab steering, mode may enable a wider range of maneuvers for the machine 10 in contrast to a machine limited to coordinated steering. The orientation of the left crab steering mode shown in FIG. 5 is approximately 40° relative to the longitudinal centerline or axis b-b′ of the machine 10, although numerous angle options are available.

For example, the machine 10 may offer a range of crab steering angles of between 0° to 60°. Just by way of conventional reference, when the tracks are parallel to the centerline axis of the machine 10, the machine 10 will travel in a straight line, and the crab steer angle is said to be 0° because the tracks are then parallel to the axis b-b′. Departing from the 0° track angle, a computerized system containing lookup tables may be employed to provide perfectly parallel crab steer track angles up to the maximum available crab angle of steer.

In-cab operator selection of the various modes, including the crab mode, may be made via use of a switch on the operator station 28. The operator may then employ the steering control unit 30, which may be a wheel or a joystick, to physically turn the tracks to any desired position. In both Ackerman coordinated and crab modes, as the operator moves the joystick, the front and rear steering actuators 36, 38 are adapted to control the angles of both front and rear tracks, respectively. While in crab mode, however, the lengths of the front and rear tie rods 40, 40′ may be adjusted via front and rear linear actuators 60 and 60′, respectively, to maintain all tracks in parallel orientation, as demonstrated in FIG. 5. Such adjustment may be entirely automated via use of software maps that relate the length of each tie rod 40, 40′ to the amount of extension of respective steering actuators 36, 38.

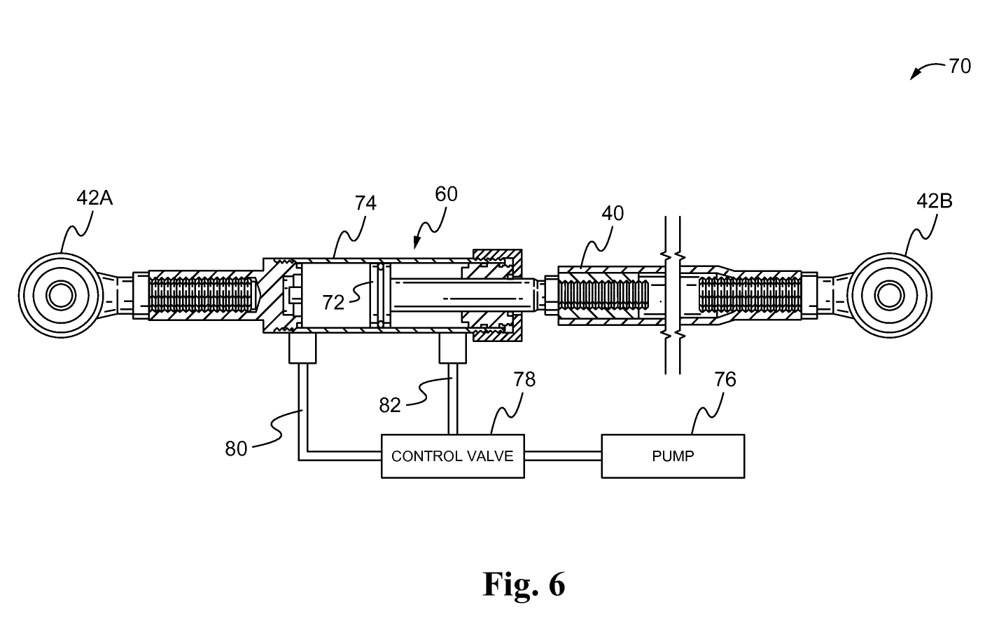

Referring now to FIG. 6, a linear actuator control system 70 is shown schematically. The control system 70 schematically includes the noted front tie rod 40, having ends 42A and 42B. The tie rod 40 incorporates the linear actuator 60 as previously noted. The same control system 70 or another similar control system may also be employed to control the rear tie rod 40′ and its associated linear actuator 60′ (both shown in FIGS. 2 and 5).

Continuing reference to FIG. 6, a hydraulic double acting piston 72 is axially movable within an actuator cylinder 74 by means of hydraulic oil pressures on either side of the piston, as controlled by a pump 76 and control valve unit 78. Hydraulic fluid lines 80 and 82 are positioned at opposed ends of the cylinder 74, and interface therewith to urge the piston either rightward or leftwardly. Thus, when pressure of the hydraulic line 80 exceeds that in hydraulic line 82, an extension of the tie rod 40 will occur, causing the tie rod ends 42A and 42B to become further spaced apart.

Conversely, when pressure of hydraulic line 82 exceeds that in hydraulic line 80, a retraction of the tie rod 40 will occur, causing the tie rod ends 42A and 42B to move axially closer together. This reciprocal movement may thus be effective to linearly retract or expand the tie rod 40, as will be appreciated by those skilled in the art, and thus to vary the tie rod length in accordance with real-time demands. The use of computerized software enabled lookup tables as noted earlier, in conjunction with such described hydraulic action, may be effective to provide a much improved crab steering mode for the machine 10.

Although the foregoing description addresses several contemplated embodiments of the disclosure, numerous other variations may be contemplated to fall within the spirit and scope thereof. By way of further example, although the independent front steer mode has been detailed in connection with the rear tracks being biased to center during execution of that mode, another variation of the independent front steer mode might provide that the rear tracks remain in their last commanded steer position. In yet another variation, the independent front steer mode may be adapted to permit activation of the linear actuator to move the front tie rod, permitting an adjustment of front tracks to parallel or even to a hybrid angle between coordinated and parallel orientations may be available during a normally otherwise coordinated mode, for example. Those skilled in the art will appreciate that other variations, including modes, may fall within the scope of this disclosure, including, as yet another example, a manual capability that optionally offers selectively variable and/or fixed tie rod accommodations for front and rear tie rods, albeit either separately or simultaneously.

Thus, the scope of the present disclosure should not be limited to only the embodiments described in detail, as the breadth and scope of the disclosure is contemplated to be broader than any of the detailed embodiments presented.

### INDUSTRIAL APPLICABILITY

This disclosure may offer particular benefits for steering systems utilized in machines having continuous tracks, also called crawler tracks, as typically employed on bulldozers and cold planar milling machines. Specifically, the disclosure offers an improved steering system for accommodating multiple functional steering modes, including a coordinated front and rear track steering mode, an independent front track steering mode, and a crab steering mode under which all tracks may be oriented parallel to one another and adapted to roll in the same direction.

In addition, the machine may incorporate a rear steer override feature adapted to provide enhanced functionality, and adapted to be actuable irrespective of any steering mode that may be active at the time. If for example, during a crab maneuver a ground operator notices that the rear tracks could conveniently be momentarily “re-oriented” to avoid an obstacle, e.g. an upstanding drain structure, the ground operator might radio the cab operator to advise to temporarily utilize the rear override to orient the rear tracks to avoid the structure. As noted, such rear steer capability may be actuated during any other mode as well (whether four-track coordinated or independent front steer).

In operation, a cold planar milling machine 10 may, for example, be controlled for coordinated Ackerman steering of its front and rear crawler tracks in one steering mode, while having the capability for adjustability of its tie rods in order to accommodate perfectly parallel crab mode steering. An operator may simply toggle a switch to achieve either one of the afore-described modes, as may be desired under given circumstances and/or for effective operation of the machine.

In other potential contemplated disclosed embodiments, actual track orientation during operation of the rear steer override feature rear may be any of a) a coordinated steer configuration of the rear tracks, b) a parallel steer configuration of the rear tracks, or c) an in-between hybrid steer configuration of the rear tracks, each depending upon the specific configuration desired by an operator for a given set of circumstances.

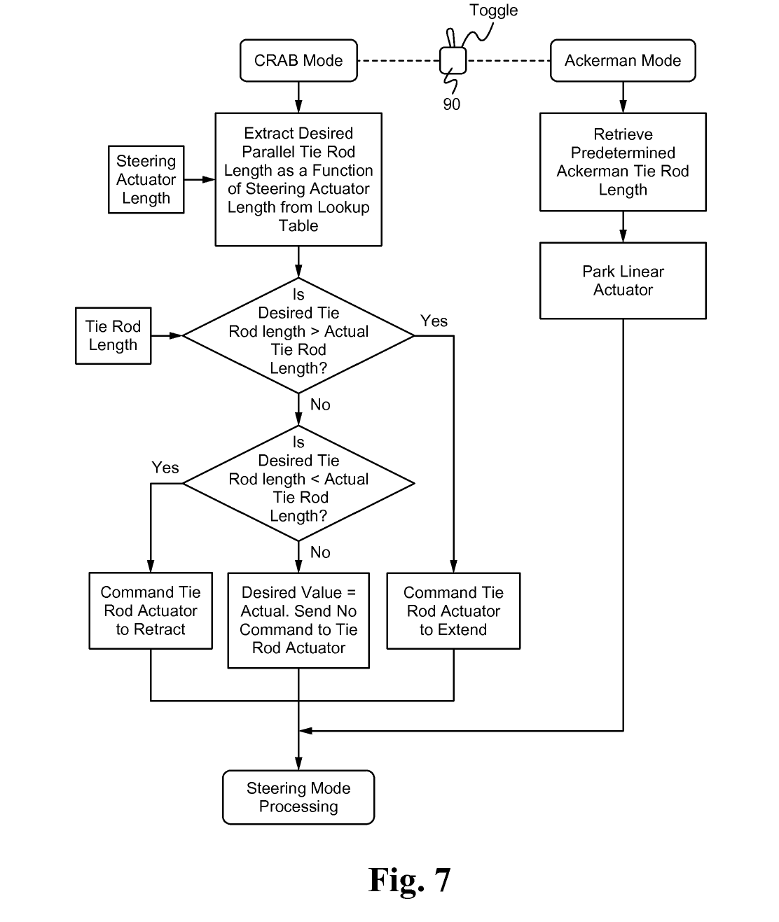

Referring to FIG. 7, a block diagram is used to depict an algorithm representing an exemplary operation of the linear actuator control system 70, both when the machine 10 is in a crab steering mode and when the machine 10 is in one of the Ackerman coordinated steering modes. During an Ackerman mode the machine 10 may use predetermined steering linkage geometry to achieve its coordinated turns, and the linear actuator control system 70 may thus be adapted to signal the linear actuators 60, 60′ to place or park the adjustable tie rods into predetermined fixed positions. On the other hand, during the crab mode operation of the machine 10 the linear actuator control system 70 may be adapted to signal the linear actuator to move dynamically in accordance with system performance demands.

Thus, FIG. 7 depicts a switch 90 for selecting between crab and Ackerman modes, including a coordinated four-track as well as an independent front track steer mode. If an Ackerman mode is selected, the contemplated control system 70 may incorporate computerized software (not shown) adapted to retrieve and enable a predetermined Ackerman linkage-dependent tie rod length. Under such circumstances, the linear actuator would be parked in a fixed position corresponding to a predetermined Ackerman tie rod length, based solely on fixed steering linkage geometry. Such a fixed tie rod length may satisfactorily accommodate any Ackerman turn commanded by the machine 10.

In the crab mode, however, the linear actuator control system 70 may enable dynamic movement of the linear actuator, and the tie rod lengths of both front and rear tracks would accordingly be adjusted as a function of inputs from the steering control unit 30 (FIG. 1), as determined by real-time lengths of front and rear steering actuators 36, 38. Thus, during crab mode the algorithm of FIG. 7 may activate selections of any desired tie rod lengths via use of look up table software as earlier noted. Accordingly, any necessary adjustments of the linear actuators 60, 60′ would provide desired tie rod lengths for any desired crab angle, based upon real-time comparisons to actual or real time tie rod lengths.

1. A machine comprising:
first and second pairs of steerable tracks for effecting movement of the machine;
a tie rod coupled between each of the first and second pairs of tracks;
a linear actuator positioned on each tie rod for adjusting the length of the respective tie rod; and
a controller configured to receive a steering mode from one of at least a crab steering mode and a coordinated steering mode, and when the steering mode is a crab steering mode, to determine each tie rod length according to a steering angle such that the tie rod lengths are adapted to be adjusted in real time to orient each of the first and second tracks parallel to one another for the steering angle, and to communicate with the linear actuator to adjust the tie rod to the determined length;
wherein when the steering mode is a coordinated steering mode, the controller is further configured to communicate with the linear actuator to fix the tie rod at a predetermined coordinated steering length, and the first and second pairs of tracks are adapted to achieve coordinated steering turning angles through steering linkage.

2. (canceled)

3. The machine of claim 1, further comprising a steering collar assembly for each track, wherein the tie rod coupled between each of the first and second pairs of tracks has each end thereof rotatably affixed to one of the steering collar assemblies.

4. The machine of claim 1, wherein the machine comprises a cold milling machine.

5. The machine of claim 1, further comprising a steering actuator coupled to and extending from each pair of first and second tracks, each steering actuator being adapted to steer its respective associated pair of tracks.

6. The machine of claim 5, each tie rod has an on-demand, variably adjustable length as a function of amount of extension and retraction of the steering actuator, and wherein tie rod adjustments are continuously enabled during the crab steering mode.

7. The machine of claim 1, further comprising an independent front steer mode, and wherein if the steering mode received by the controller is an independent front steer mode, the first pair of tracks is steerable, and the second pair of tracks is biased to a zero turn angle.

8. The machine of claim 1, further comprising a rear steer override feature, and wherein if the override feature is activated, the second pair of tracks becomes independently steerable, irrespective of steering mode selected.

9. The machine of claim 1, further comprising a hydraulic fluid system for operating the linear actuator.

10. A linear actuator control system comprising:
a machine including first and second pairs of steerable tracks for effecting movement of the machine;
a tie rod coupled between each of the first and second pairs of tracks;
a linear actuator positioned on each tie rod for adjusting the length of the respective tie rod;
a steering mode selector configured to transmit a steering mode for selectively orienting the first and second pairs of tracks, the steering mode selected from one of at least a crab steering mode and a coordinated steering mode; and
a controller coupled to the steering mode selector and the linear actuator, the controller configured to receive the steering mode and communicate with the linear actuator with respect to tie rod length according to the steering mode;
wherein when the steering mode selected is the crab steering mode, the controller determines each tie rod length according to a steering angle such that the tie rod lengths are adapted to be adjusted in real time to orient each of the first and second tracks parallel to one another for the steering angle, and to communicate with the linear actuator to adjust the tie rod to the determined length; and
wherein when the steering mode selected is the coordinated steering mode, each of the tie rods are fixed to a predetermined coordinated steering length and the first and second pairs of tracks are adapted to achieve coordinated steering turning angles through steering linkage.

11. (canceled)

12. The linear actuator control system of claim 10, wherein when the steering mode selected is the crab mode, each tie rod length is determined according to a steering angle such that the tie rods orient each of the first and second tracks parallel to one another for the steering angle.

13. The linear actuator control system of claim 10, wherein the machine further comprises a cold milling machine.

14. The linear actuator control system of claim 10, further comprising a steering actuator coupled to and extending from each of the first and second pair of tracks, each of the steering actuators being adapted to steer a respective one of the first and second pair of tracks.

15. The linear actuator control system of claim 14, wherein each tie rod has an on-demand, variably adjustable, length as a function of amount of extension and retraction of the steering actuator, and wherein tie rod adjustments are continuously enabled during the crab steering mode.

16. The linear actuator control system of claim 10, further comprising an independent front steer mode, and wherein if the steering mode received by the controller is an independent front steer mode, the first pair of tracks is steerable, and the second pair of tracks is biased to a zero turn angle.

17. The linear actuator control system of claim 10, further comprising a rear steer override feature, and wherein if the override feature is activated, the second pair of tracks becomes independently steerable, irrespective of steering mode selected.

18. The linear actuator control system of claim 10, further comprising a hydraulic fluid system for operating each of the linear actuators.

19. A method of steering a machine including first and second pairs of steerable tracks, comprising the steps of:
selectably engaging a steering mode selected from one of at least a crab steering mode and a coordinated steering mode; and
when the crab steering mode is engaged:
determining a steering actuator length for each of the pairs of steerable tracks according to a steering angle,
determining a desired tie rod length for each of the pairs of steerable tracks to achieve the steering angle as a function of the determined steering actuator length,
comparing the tie rod length for each of the pairs of steerable tracks with the desired tie rod length for each of the pairs of steerable tracks,
adjusting the tie rod to the desired length for each of the pairs of steerable tracks, such that all tracks are oriented parallel to one another for the steering angle; and
when the coordinated steering mode is engaged;
fixing the steering actuator and tie rod to predetermined coordinated steering mode length for each of the pairs of steerable tracks.

20. (canceled)
